(19) United States
(12) Patent Application Publication
(10) Pub. No.: US 2008/0137065 A1
(43) Pub. Date: Jun. 12, 2008

(54) Measuring Analyte Concentrations in Liquids

(76) Inventors: Derek R. Oberreit, Roseville, MN (US); Frederick R. Quant, Shoreview, MN (US); David B. Blackford, North Oaks, MN (US)

Correspondence Address: HAUGEN LAW FIRM, SUITE 1130 - TCF TOWER, 121 SOUTH EIGHTH STREET, MINNEAPOLIS, MN, 55402, US

(21) Appl. No.: 11/935,824

(22) Filed: Nov. 6, 2007

Related U.S. Application Data
(60) Provisional application No. 60/857,609, filed on Nov. 7, 2006.

(51) Int. Cl. G01N 1/00; B01D 47/00; G01N 30/00

(52) U.S. Cl. 356/37; 261/78.1; 73/53.01

(57) ABSTRACT

A high performance liquid chromatography system employs a nebulizer with a flow restriction at the exit of its mixing chamber to produce finer droplets, and an adjustable impactor for increased control over droplet sizes. Downstream of the mixing chamber, the nebulizer can incorporate tubing that is permeable to the sample liquid, to promote aerosol drying through perevaporation. A condensation particle counter downstream of the nebulizer uses water as the working medium, and is adjustable to control threshold nucleation sizes and droplet growth rates. A particle size selector employing diffusion, electrostatic attraction or selection based on electrical mobility, is advantageously positioned between the nebulizer and the CPC.

This application claims the benefit of priority based on Provisional Patent Application No. 60/857,609, entitled “System for Separating Non-volatile Analytes and Measuring Analyte Concentrations,” filed Nov. 7, 2006.

### BACKGROUND OF THE INVENTION

The present invention relates to systems for measuring minute concentrations of constituents dissolved in liquids, and more particularly to systems that employ analyte separation and aerosol generation to distinguish constituents and measure their concentrations.

A variety of instruments are used for identifying and measuring concentrations of solutes in liquid media. Separators can employ any one of several analyte separation techniques, e.g. liquid chromatography, high performance liquid chromatography (normal or reversed phase), ion exchange chromatography and gel permeation chromatography. Analyte separation involves moving liquid and dissolved constituents, known as the mobile phase, through a stationary phase, e.g. a stainless steel column or tube packed with 5-10 mm silicon beads. As the liquid passes through the column, different analytes become separated from one another due to differing rates at which they travel through the stationary phase. The liquid leaving the stationary phase is comprised of spatially separated concentrations of the individual analytes. As a result, a continuous measurement of the liquid stream yields a chromatogram in which indications of relatively high concentration are temporally separated from one another to suggest the presence of different analytes. The chromatogram corresponds to the physical separation of the analytes at the column exit, by recording the different times at which different analyte concentrations leave the column. The exit times are useful in identifying the analytes involved.

Among the techniques for measuring analyte concentrations, several involve generating aerosols based on the mobile phase exiting the column. In one of these, known as evaporative light scattering, a nebulizer is used to generate droplets of the solution eluting from the separator column. The droplets dry as they are carried by air or another gas, forming a stream of non-volatile residue particles. As the particles are moved past a laser beam, each particle that intersects the beam scatters light, with larger particles scattering light at higher intensity. Thus, the amplitude of a photodetector output provides a measurement of particle size, which in turn provides an indication of analyte concentration.

To enhance measurement of small analyte concentrations, the particle stream can be directed through a condensation particle counter (CPC), in which the particles travel through a region saturated with the vapor of a working medium that condenses onto the non-volatile residue particles that exceed a threshold diameter, “growing” each particle into a considerably larger droplet that is more easily detected by optical means.

In another technique, known as evaporative electrical detection, the solution leaving a separator column is nebulized to provide an aerosol stream, with the droplets again dried to provide a particle stream. The particle stream is brought into a confluence with a stream of ions, to apply a size-dependent electrical charge to the non-volatile residue particles. An electrically conductive filter collects the particles and generates an electrical current indicative of analyte concentration.

While the systems are well suited for a variety of applications, they are subject to difficulties that limit their utility. One of these is the lack of sensitivity sufficient for detecting and measuring extremely low analyte concentrations. As environmental standards for exposure to various contaminants become more stringent, and as product testing and manufacturing techniques are directed to applications that require more accurate measurement of constituents or have a reduced tolerance to certain constituents, there is an ever increasing need to measure smaller amounts of analytes with accuracy.

Another difficulty concerns bubble formation due to gasses dissolved in the water or other liquid entering the nebulizer. Bubbles can be formed when the liquid flow rate is below the natural aspiration rate, with the liquid drawn into the nebulizer at a pressure below atmospheric pressure. The bubbles eventually break free and tend to disrupt residue concentration measurements downstream of the nebulizer.

A further system problem, relating to the condensation particle counter, concerns the use of butyl alcohol or similar fluids with low vapor mass diffusivity for growing the residue particles into droplets. Such liquids tend to be flammable, toxic, and produce noxious odors. Frequently they are subject to health and environmental regulations that restrict their use in indoor environments. In addition, the liquids require equipment for supplying, collecting and recirculating the liquid involved, and in some cases for separating the liquid from water.

Another persistent problem, due to relatively long fluid flow paths within and between the nebulizer and CPC, is the relatively long time elapsed between a change in the concentrations of analytes in a given liquid sample, and the detection of the change. The longer paths allow more time for axial diffusion, which ultimately has a negative impact on the instrument response.

Another difficulty with conventional condensation particle counters is the limited dynamic range typical of many CPC designs, due primarily to the increase in coincidence events that accompanies increased particle concentration.

Accordingly the present invention has several aspects, directed to one or more of the following objects:
to provide a system for detecting analyte concentrations based on droplet growth and optical droplet sensing based on nonflammable and nontoxic working media;
to provide, in systems using nebulizers to generate liquid sample aerosols, more rapid and effective evaporation to dry the nebulizer output;
to provide a process for extending the dynamic range of a condensation particle counter;
to provide a nebulizer with a mixing chamber better suited to generate finer aerosol droplets;
to provide an optical detector with enhanced flexibility for determining particle nucleation thresholds and for accommodating a wider variety of condensation media; and
to remove smaller, more volatile particles from the aerosol to enhance volatile analyte detection.

### SUMMARY OF THE INVENTION

In general, the invention is drawn to a system for analyzing liquid samples including an analyte separator, an aerosol generator for producing an aerosol stream of suspended particles derived from the liquid output of the separator, and a particle sensing device responsive to the particles for measuring analyte concentrations.

One aspect of the invention is a system for measuring analyte concentrations in liquids. The system includes an analyte separation stage adapted to separate different analytes in a liquid sample primarily into different regions within the liquid sample. This produces a separation stage output in which a plurality of different analytes are so separated. A nebulizing stage, downstream of the analyte separation stage, is adapted to generate an aerosol stream composed of droplets of the separation stage output suspended in a carrier gas. An evaporation stage, downstream of the nebulizing stage, is adapted to substantially evaporate the liquid whereby the aerosol leaving the evaporation stage is composed of residue particles of the different analytes suspended in the carrier gas. A saturation stage, disposed downstream of the evaporation stage, is maintained substantially at a first temperature, and adapted to merge the aerosol with a working medium vapor having a mass diffusivity higher than a thermal diffusivity of the carrier gas, to substantially saturate the aerosol with the working medium vapor. A condensation stage, disposed downstream of the saturation stage, is maintained at a second temperature above the first temperature, and adapted to merge further working medium vapor with the substantially saturated aerosol to supersaturate the aerosol and thereby cause droplet growth through condensation of the working medium onto the residue particles. A sensing stage, downstream of the condensation stage, is adapted to optically sense the droplets and generate electrical signals useful in indicating analyte concentrations.

In preferred systems, the saturation stage, condensation stage and sensing stage are provided by a condensation particle counter (CPC). These systems can use water, whose vapor has a relatively high mass diffusivity, as the working or condensing medium. Using water avoids the health and environmental concerns associated with butyl alcohol and other perflourinated hydrocarbons. This eliminates the need to supply, store and recover such fluids, and to separate such fluids from the water.

When water is used as the working medium, the aerosol stream is saturated with water vapor and proceeds to a condensing region surrounded by wetted walls that are heated to provide a temperature higher than that of the saturated aerosol stream. Maximum supersaturation occurs at the center of the aerosol flow, given that the water vapor and heat both travel radially inward, and the mass diffusivity of water exceeds the thermal diffusivity of air.

One advantage of using water as the working fluid in the CPC is a substantially higher threshold at which spontaneous nucleation (also called homogeneous nucleation) occurs, compared to a CPC in which working medium is butyl alcohol. An improved coincidence correction process also contributes to a considerably higher permitted particle throughput rate. As a result of these advantages, the concentration information is available virtually in real time, and can encompass concentrations ranging from a single part per trillion to ten parts per million in the single count mode. If desired, a photometric mode can be employed to increase the upper limit to over one part per thousand.

Another aspect of the invention is a system for analyzing liquids. The system includes an analyte separator adapted to separate different analytes in a liquid sample primarily into different regions within the liquid sample, thereby to produce a separator output in which a plurality of different analytes are so separated. A nebulizer is fluid coupled to receive at least a portion of the separator output, and to generate an aerosol composed of droplets of the liquid suspended in a carrier gas. A conduit structure is provided for guiding travel of the aerosol in an aerosol stream away from a merger zone of the nebulizer. At least a portion of the conduit structure is permeable to the liquid, to promote an evaporation of the liquid and migration of the vapor through that portion of the conduit to an exterior thereof as the aerosol is conveyed along the conduit structure. The aerosol leaving the conduit structure is composed of residue particles of the analytes suspended in the carrier gas. A concentration indicating component is disposed to receive the aerosol leaving the conduit structure, and is adapted to indicate analyte concentrations based on the residue particles received.

The concentration indicating component can comprise a droplet growth component disposed downstream of the conduit structure to receive the aerosol and merge the aerosol and a working medium vapor, to supersaturate the aerosol and thereby cause droplet growth through condensation of the working medium onto the residue particles. In this case, the concentration indicating component further includes a droplet sensing component, downstream of the condensation component, adapted to optically detect the droplets and generate electrical signals indicating analyte concentrations.

The conduit structure can be incorporated into the nebulizer, or can be provided as a length of tubing running between the nebulizer and the droplet growth component, e.g. a condensation particle counter. A preferred material for the tubing or nebulizer interior wall is a copolymer available from E. I. duPont de Nemours and Company of Wilmington, Del. under the brand name “Nafion.” So long as the ambient environment surrounding the tubing or nebulizer is less humid than the aerosol, the liquid evaporates and migrates outwardly through the wall in a process referred to as “perevaporation,” resulting in a rapid drying of the aerosol stream. In addition to water, the Nafion tubing can remove alcohols, amines and ammonia from the aerosol stream. The more rapid removal of vapors can permit a considerably shorter aerosol pathway between the nebulizer and the CPC. A key feature of the Nafion conduit structure is that it facilitates vapor removal at lower temperatures, for improved detection of volatile analytes.

The nebulizer can incorporate a heating element just downstream of the impactor, and an inlet downstream of the heating element for admitting dry air to dilute the aerosol stream and reduce the dew point of the liquid vapor.

Another aspect of the invention is a system for analyzing liquid samples. The system includes an analyte separator adapted to separate analytes in a liquid sample primarily into different regions within the liquid sample, to produce a separator output in which a plurality of different analytes are so separated. A nebulizer is fluid coupled to receive at least a portion of the separator output in a merger zone thereof, to generate an aerosol composed of droplets of the liquid suspended in a carrier gas. An evaporation stage, downstream of the nebulizer, is adapted to substantially evaporate the liquid whereby the aerosol leaving the evaporation stage is composed of residue particles of the different analytes suspended in the carrier gas. An electrostatic selector is disposed downstream of the evaporation stage and adapted to selectively remove, from the aerosol, residue particles having sizes less than a predetermined threshold. A concentration indicating component downstream of the selector is adapted to generate analyte concentration information based on residue particles received from the selector.

The concentration indicating component can comprise an optical particle counter adapted to cause growth of droplets through condensation of a working medium onto the residue particles, then optically sense the resulting droplets to generate indications of analyte concentrations.

In one version of the system, the electrostatic selector comprises a unipolar electrical charging device, e.g. a corona discharge element generating multiple ions to merge with the aerosol and charge the particles. This is followed by an ion trap selectively biased to remove the ions and particles having higher electrical mobilities. In another version of the system, the selector comprises a neutralizer which applies a bipolar charge to the aerosol particles, followed by a differential mobility analyzer (DMA). An aspect of this version is that the DMA can be used to remove residue particles on both sides of a desired range of particle electrical mobilities, in effect setting an upper limit as well as a lower limit for particle retention. Either of these versions can be used to improve the response to volatile analytes. In addition, analyte concentration information can be generated by means other than optical particle counting.

Yet another aspect of the invention is a device for generating an aerosol composed of multiple droplets of a liquid. The device includes a housing forming a mixing chamber having (i) a liquid entrance for receiving a sample liquid into the chamber, (ii) a primary orifice having a first diameter for receiving a pressurized gas into the chamber for merger with the sample liquid to generate an aerosol composed of multiple droplets of the sample liquid suspended in the gas, and (iii) a secondary orifice having a second diameter for conducting the aerosol out of the chamber. The second diameter is less than a major dimension of the mixing chamber taken in a direction substantially perpendicular to an axis of the secondary orifice, so as to restrict flow out of the mixing chamber to generate a back pressure in opposition to entry of the sample liquid and the pressurized gas into the chamber.

In contrast to previous nebulizers in which the chamber exit is simply open to the downstream components with a diameter equal to that of the chamber, the exit orifice in the present nebulizer has a diameter less than that of the chamber, and more preferably less than half the chamber diameter. The diameter reduction provides a constriction which produces a higher kinetic energy mixing of the gas and separator eluent in the merger zone. As a result, the nebulizer generates smaller droplets. The secondary orifice also helps direct the aerosol towards the impactor raising the impactor efficiency

Another factor reducing droplet size is a close axial positioning of an impactor, just downstream of the secondary orifice. The more closely spaced impactor removes a greater proportion of the larger droplets, reducing baseline concentration (noise) for improved dynamic range in generating analyte concentration data.

In a preferred version of the nebulizer, the impactor axial spacing from the secondary orifice is adjustable through movement of the impactor. For example, a threaded mounting of the impactor to the nebulizer frame allows axial position adjustment by turning the impactor about its longitudinal axis. The average size of droplets in the aerosol leaving the nebulizer can be increased or decreased by respectively enlarging or reducing the axial spacing between the secondary orifice and the impactor.

The droplet size also can be adjusted by changing or selecting the secondary orifice. Reducing the diameter of the secondary orifice is believed to increase back pressure and reduce droplet size. It has been found useful to provide a secondary orifice with a diameter larger than that of the primary orifice. The ratio of the secondary orifice diameter to the primary orifice diameter can range from slightly above one, to about two in versions that incorporate a secondary orifice.

A further aspect of the invention is a device for optically detecting fine particles in an aerosol. The device includes a housing having an inlet for receiving an aerosol consisting essentially of substantially dry submicrometer residue particles suspended in a carrier gas, and a passage for conveying the aerosol in a steady stream through the housing along a saturation region and along a supersaturation region downstream of the saturation region. A holding component, disposed along the passage, is adapted to contain a condensing medium in liquid form and to release the condensing medium in vapor form as the aerosol is conveyed along the passage. A first temperature maintenance device, disposed proximate the passage along the saturation region, is adapted to maintain the saturation region substantially at a first temperature. A second temperature maintenance device, disposed proximate the passage along the supersaturation region, is adapted to maintain the supersaturation region substantially at a second temperature different from the first temperature. A controller operably associated with the temperature maintenance devices for selectively setting the first temperature, the second temperature, and a difference between the first and second temperatures, to selectively vary a nucleation threshold at which the particles are capable of serving as nuclei for condensation of the working medium to grow droplets. A droplet detector, disposed at a sensing location downstream of the passage, is adapted to sense the droplets resulting from said condensation as they pass the sensing location.

In detectors (e.g. condensation particle counters) that use working media with mass diffusivities higher than the thermal diffusivity of air or another gas, the controller and temperature maintenance devices are configured to maintain the second temperature within a higher range than that of the first temperature, for a supersaturation region that is warmer than the saturation region. Conversely, in a CPC using lower mass diffusivity media such as butyl alcohol, the first temperature is maintained within the higher range to insure that the supersaturation region is cooler than the saturation region. In either event, the difference between the first and second temperatures can be selectively adjusted to influence droplet nucleation and growth. For example, increasing the difference between the first and second temperatures lowers the nucleation threshold, tending to increase the number of particles sensed and therefore counted.

In another version of the device, the first and second temperature ranges are substantially overlapping, in which case the controller can be used to select either the saturation region or the supersaturation region as the warmer region.

Thus, analyte measuring systems configured according to the present invention generate more reliable concentration information in virtually real time and over a wider range of residue concentrations.

### IN THE DRAWINGS

For a further understanding of the above and other features and advantages, reference is made to the following detailed description and to the drawings, in which:

FIG. 1 is a block diagram of a liquid chromatography system configured in accordance with the present invention and employing high performance liquid chromatography;

FIG. 2 is a schematic view of part of the system;

FIG. 3 is a sectional side elevation of a nebulizer of the system;

FIG. 4 is a sectional view taken along the line 4-4 in FIG. 3;

FIG. 5 is an enlarged view showing part of FIG. 4;

FIG. 6 is a sectional elevation of a condensation particle counter of the system;

FIG. 7 is a graphical representation of certain electrical signals used in of the system;

FIGS. 8 and 9 illustrate alternative embodiment condensation particle counters used with the system;

FIGS. 10, 11 and 12 illustrate portions of alternative systems that incorporate particle selection features;

FIG. 13 is a schematic view of an alternative arrangement for drying an aerosol as it is conveyed from a nebulizer mixing region;

FIG. 14 schematically illustrates part of an alternative system with a “mixing type” condensation particle counter; and

FIG. 15 illustrates part of an alternative system condensation particle counter incorporating photometric particle detection.

### DETAILED DESCRIPTION OF THE PREFERRED EMBODIMENTS

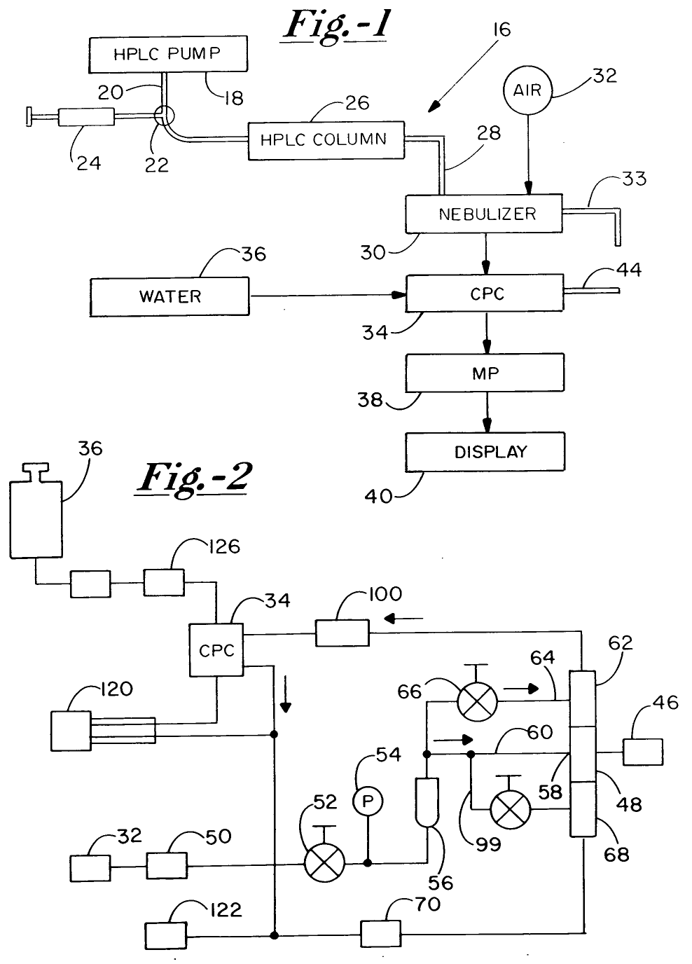

Turning now to the drawings, there is shown in FIG. 1 a diagram of a high performance liquid chromatography (HPLC) system 16 for identifying and measuring concentrations of non-volatile residue constituents dissolved in water or another liquid. The system includes a high performance liquid chromatography pump 18 for supplying water or another solvent as a carrier liquid (mobile phase) through a conduit 20 at a predetermined constant flow rate, e.g. 1 milliliter per minute. An injection valve 22 along conduit 20 is coupled to a syringe 24 containing a liquid sample and operable in stepped fashion to introduce substantially instantaneous injections of the liquid sample into the carrier liquid stream. The injections do not undergo any substantial mixing with the carrier liquid, but instead form plugs of the liquid sample that remain substantially separate from the carrier liquid. The liquid sample includes a base liquid such as water, acetonitrile (CH₃CN), or alcohols, along with non-volatile residue and other analytes or constituents dissolved in the base liquid.

Beyond valve 22, the carrier liquid (mobile phase) and plugs travel at the predetermined flow rate into a high performance liquid chromatography column 26. Column 26 includes a stainless steel tube loaded with a stationary phase, e.g. silicon beads as noted previously. The liquid sample plugs move through column 26 along with the carrier liquid. As each plug proceeds through the column, different constituents travel through the column at different rates, depending largely on their chemical attraction to the stationary phase as compared to their chemical attraction to the mobile phase. Materials having stronger interaction with the stationary phase tend to travel more slowly, as compared to materials having stronger interactions with the mobile phase. As a result, different constituents tend to become concentrated in different regions of each liquid sample plug as it travels through column 26. Consequently, each plug as it leaves column 26 has distinct regions with different concentrations of different constituents, separated from one another temporally as well as spacially since the with liquid sample is moving at the predetermined flow rate as it leaves the HPLC column.

A conduit 28 transfers either all or a predetermined fraction of the HPLC column output to a pneumatic nebulizer 30. The nebulizer also receives air, nitrogen or another gas under pressure from a pressurized gas source 32. Within nebulizer 30, the liquid sample and compressed gas are merged to generate an aerosol including droplets of the liquid sample suspended in the gas.

Most of the liquid provided to nebulizer 30, over 95 percent and typically closer to 100 percent, is not used to form droplets, but instead is drained from the nebulizer through a waste conduit 33.

The aerosol stream is dried to reduce the aerosol droplets to suspended residue particles. Then the aerosol stream is provided to a condensation particle counter (CPC) 34. As the aerosol travels through the CPC, it is first saturated with water from a working fluid supply 36. Then, the aerosol is channeled through a condensation or supersaturation region in which the residue particles act as nuclei for condensation. The residue particles “grow” into considerably larger droplets that are optically detected and counted to generate non-volatile residue concentration information. The concentration information is provided to a microprocessor 38. The microprocessor provides the information to a video display terminal 40 to generate a continuously updated record of non-volatile residue concentrations in the liquid sample.

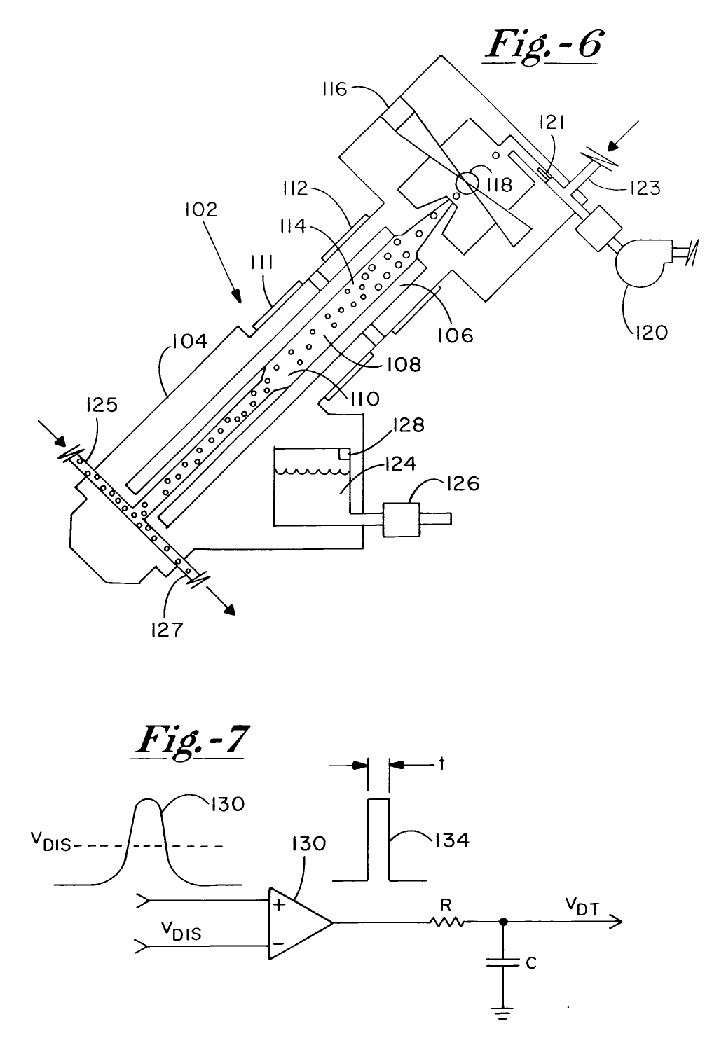

CPC 34 includes an exit 44 through which the aerosol is drawn by a pump 120 (FIG. 2) out of the CPC. In addition, excess aerosol not used in the particle count and excess water are exhausted as noted in connection with FIGS. 2 and 6.

FIG. 2 illustrates in more detail the portion of system 16 downstream of HPLC column 26. The liquid output of HPLC column 26 is provided through a bulkhead fitting 46 into a merger zone 48 of nebulizer 30, at a flow rate determined by the flow rate through the HPLC column and the fraction of the column output directed to the merger zone. In system 16, a suitable flow rate is one milliliter per minute.

Air from source 32 is provided through a solenoid valve 50 to a regulator 52 and measured using a pressure transducer 54. Downstream, the air passes through a high efficiency particle air (HEPA) filter 56, and then is supplied via an entrance 58 to merger zone 48 at a pressure of 30 psi and a flow rate of 0.6 liters per minute through a conduit 60. Air also is provided to an aerosol conditioning zone 62 of nebulizer 30 through a conduit 64. Conduit 64 includes either a valve or a control orifice 66 for limiting the air flow to a rate of about 2.7 liters per minute.

Nebulizer 30 includes a reservoir 68 in fluid communication with the merger zone. The reservoir collects most of the mobile phase supplied through conduit 28, i.e. the liquid not used to form the aerosol droplets. A pump 70 is coupled to the reservoir for evacuating the waste liquid from nebulizer 30.

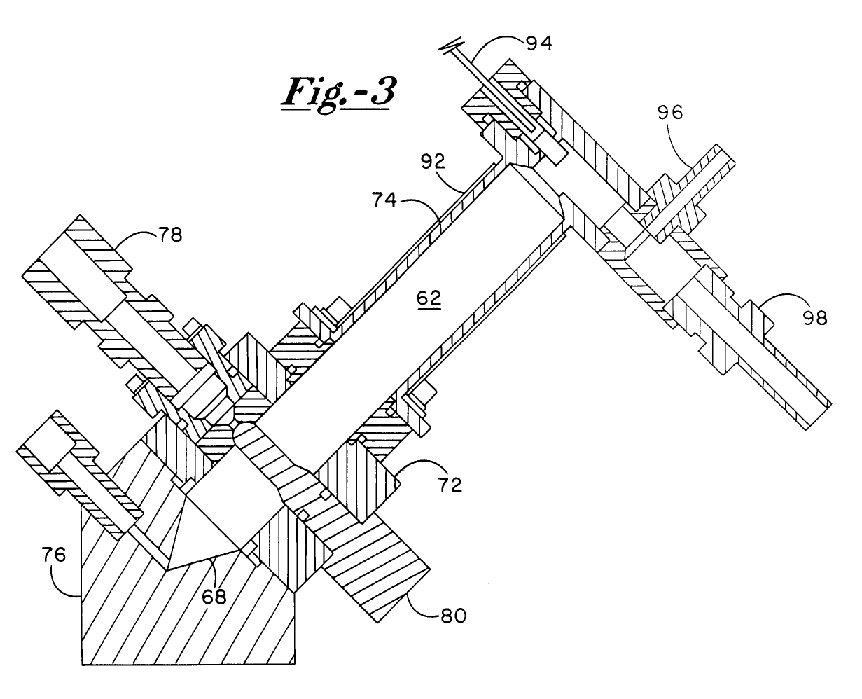

FIGS. 3-5 illustrate nebulizer 30 in more detail. The inclined orientation shown is advantageous for liquid drainage and evacuation, although not critical. A housing of the nebulizer has several integrally coupled sections, including a stainless steel housing section 72 that encloses merger zone 48, a steel housing section 74 forming the aerosol conditioning zone, and a housing section 76 providing the reservoir. Housing section 72 supports a fitting 78 for receiving the air or other compressed gas from conduit 60. This housing section also supports an impactor 80, through a threaded engagement that permits adjustment of the axial spacing between impactor 80 and merger zone 48.

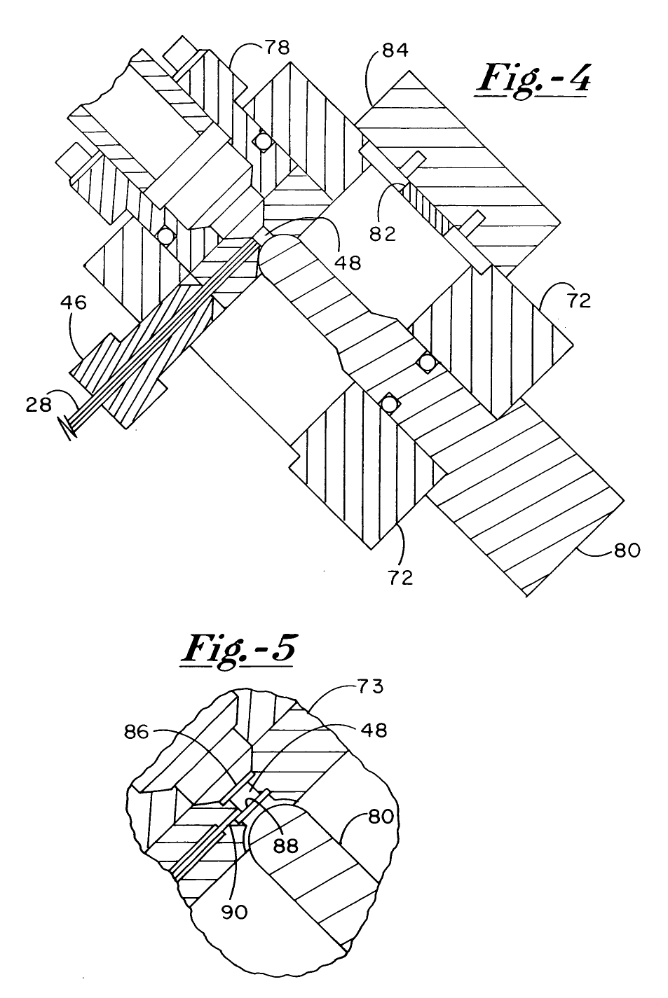

With reference to FIG. 4, housing section 72 further supports a thermoelectric device 82 that functions to maintain a stable temperature of about 30° C. in the vicinity of merger zone 48. More particularly, the thermoelectric device extracts heat from housing section 72 and transfers it to a heat sink 84. The thermoelectric device also may function as a heater for the nebulizer. The constant temperature promotes consistent droplet formation. Housing section 72 further supports bulkhead fitting 46, which secures conduit 28 used to transfer the sample liquid from HPLC column 26 to merger zone 48.

As best seen in FIG. 5, merger zone 48 takes the form of a cylindrical chamber in a Teflon orifice housing 73. A sapphire orifice plate 86 defines an entrance or primary orifice to receive pressurized gas into the chamber from conduit 60. A sapphire orifice plate 88 defines an exit or secondary orifice through which the merged liquid and gas leave the chamber. In addition, a liquid receiving entrance 90 conducts the sample liquid into the chamber.

In one suitable version of nebulizer 30, primary orifice 86 has a diameter of 0.006 inches, and secondary orifice 88 has a diameter of 0.008 inches. The chamber has a diameter of 0.020 inches, and an axial length, i.e. space in between orifice plates 86 and 88, of 0.020 inches.

More generally, the secondary orifice diameter is larger than the primary orifice diameter, yet less than the diameter of the cylindrical chamber. As compared to prior devices in which there is no secondary orifice and the chamber is simply open at the exit end, there is a back pressure due to the secondary orifice which increases the feed pressure to the merger zone and results in a higher kinetic energy mixing of the liquid and compressed gas. This advantageously results in smaller sample liquid droplets in the aerosol leaving the merger zone.

As the size of the secondary orifice is reduced, the droplet size is reduced and the back pressure is increased. When the sample liquid is water, it has been found satisfactory to form the secondary orifice and the primary orifice at a diameter ratio of 2 to 1 as indicated by the diameters given above. For a sample liquid with a boiling point lower than water, the preferred diameter ratio is closer to 1, yet the secondary orifice remains larger than the primary orifice.

The higher energy in the merger zone more effectively breaks up the liquid. The secondary orifice also appears to improve the efficiency of the impactor downstream. The ratios of primary and secondary orifice diameters can be selected to vary the pressure at the liquid entrance to the merger zone, relative to atmospheric pressure. Depending on the diameter ratio, air inlet pressure and liquid flow rate (as determined by the HPLC pump), the liquid pressure can be adjusted from below atmospheric pressure to a pressure nearly equal to the inlet air pressure. Keeping the liquid near atmospheric pressure is advantageous for reducing measurement errors due to outgassing.

As seen in FIG. 5, impactor 80 is disposed coaxially with merger zone 48, spaced apart in the axial direction from orifice plate 88. The impactor cooperates with housing section 72 to form a thin, somewhat hemispherical path to accommodate the flow of air and droplets beyond the merger zone. The smaller droplets tend to follow the air flow, while the larger droplets tend to collide with impactor 80 and are removed from the aerosol stream. Thus, the aerosol moving into conditioning zone 62, upwardly and to the right as viewed in FIG. 3, includes only those droplets below a size threshold determined largely by the axial spacing between secondary orifice 88 and impactor 80. The size threshold is increased by increasing the axial spacing, and reduced by moving the impactor closer to orifice plate 88.

The droplets impinging upon impactor 80 may remain on the impactor momentarily, but eventually descend to reservoir 68 to be removed from the nebulizer as needed through pump 70. If desired, impactor 80 may be formed of sintered metal to provide a porous structure that more effectively prevents the larger, impacting droplets from interfering with the aerosol flow.

As the aerosol stream proceeds along conditioning zone 62, it is heated by an electrical heating element 92 to a temperature of 35-100° C., depending on the mobile phase and analyte volatility. This evaporates the sample liquid, transforming the aerosol into a particle suspension rather than a droplet suspension by the time it reaches CPC 34. A temperature sensor 94 at the end of conditioning zone 92 is operable in conjunction with the heating element to maintain the desired temperature within the conditioning zone. The aerosol is merged with the air flow from conduit 64 through a fitting 96 to provide a diluted aerosol flow of about 3.3 liters per minute to CPC 34. Dilution reduces the dew point to sustain droplet evaporation and reduces the aerosol particle concentration as the aerosol leaves the nebulizer through a fitting 98.

With reference to FIG. 2, the aerosol proceeds from nebulizer 30 to an aerosol mixer 100, and then to condensation particle counter 34.

A secondary gas may be introduced into nebulizer 30 at a location upstream of the nebulization region as indicated at 99 (FIG. 2). The secondary gas sweeps dead space in the nebulization region resulting in a faster response, reduced axial diffusion, and less smearing of the output due to mixing.

FIG. 6 illustrates condensation particle counter 34 in more detail. The CPC includes a droplet growth column 102 including a substantially rigid cylindrical outer wall 104 and a porous cylindrical inner liner or wick 106 formed of a ceramic. Wick 106 is adapted to receive and hold water or another condensation medium, and thereby provide vapor to an internal passage 108 surrounded by the wick. If desired, wick 106 can be mounted removably to facilitate inspection and convenient replacement. A lower, saturation region 110 of passage 108 is maintained at a near ambient temperature, e.g. at 20° C. A thermoelectric device 111 is optionally used to maintain the saturation region temperature. A heating element 112 is used to maintain an upper, droplet growth region 114 of the chamber at an elevated temperature, e.g. 60° C. As the aerosol from nebulizer 30 proceeds upwardly through passage 108, it becomes saturated along region 110. As the aerosol travels through region 114, it becomes supersaturated with the vapor. All particles in the aerosol having at least a threshold size become nucleation sites for droplet growth due to water condensation.

As the particles proceed upwardly through growth region 114, two counteracting phenomena are at work. First, due to the elevated temperature the wetted wick generates increased water vapor, which travels radially inward away from the wick toward the center of passage 108. This of course promotes condensation onto the particles. Second, as the aerosol is heated, the higher temperature tends to discourage condensation. However, because of the relatively high mass diffusivity of water vapor, the water vapor reaches the center of passage 108 more quickly than the heat. Consequently the particles and their immediately adjacent air, even while being warmed, remain sufficiently cool for supersaturation and the resulting condensation and droplet growth.

A laser diode 116 and photodetector 118 are disposed above droplet growth column 102 proximate the aerosol stream. Each droplet alters or interrupts light transmission to the photodetector to generate an analog electrical pulse. The pulses are digitized and provided to processor 38, and the pulse count yields the non-volatile residue concentration.

With reference to FIG. 2 as well as FIG. 6, a pump 120 draws the aerosol out of CPC 34 through a flow metering orifice 121 and provides it to a waste outlet 122, along with a dilution air flow of about 0.8 liters per minute from a conduit 123. A sample flow of the aerosol in the range of 100-300 milliliters per minute is provided to passage 108 from a CPC inlet 125. Excess aerosol flows through an exhaust exit 127 to waste outlet 122. The CPC receives the water or other condensation medium from working fluid supply 36, preferably a 250-500 cc bottle.

As seen in FIG. 6, CPC 24 includes a reservoir 124 fluid coupled to the working fluid supply through a solenoid valve 126. Water is provided from reservoir 124 to wick 106, to insure that the wick remains wetted to provide water vapor along the saturation and growth sections. The solenoid valve normally is closed. When a level sensor 128 in the reservoir senses that the water level in the reservoir has receded below a predetermined threshold, it opens valve 126 to replenish the water supply in the reservoir. Reservoir 124 can be provided with a fitting for draining excess water if desired.

As noted previously, the use of water as the condensing fluid avoids health and environmental concerns associated with butyl alcohol and other perflourinated hydrocarbons in CPC 34.

A feature of CPC 34 is that when the particulate concentration increases, the sensitivity is reduced. One factor contributing to this result is that as more particles within a given volume serve as nucleation sites, the heat generated by condensation lowers the supersaturation ratio. This in turn raises the threshold (minimum particle size) for particle nucleation, improving the overall dynamic range of the detector. Another, more prominent factor is the increase in coincidence events with increased concentration. As each droplet intersects the coherent energy beam from diode 116 to generate the corresponding pulse, it also creates a time interval during which any other droplet also intersecting the beam is prevented from generating a pulse, and thus goes undetected.

With reference to FIG. 7, the signal generated by a droplet intersecting the beam is represented by an analog pulse 130. The broken line labeled “V_{DIS}” represents a threshold voltage for droplet detection. More particularly, the voltage V_{DIS} is provided to the negative input of a comparator amplifier 132. The sensed analog voltage is provided to the positive input of the amplifier. The output of amplifier 132 is a series of digital pulses corresponding to the analog pulses. For example, digital pulse 134 has a pulse width “t” corresponding to the discriminator time for pulse 130, i.e. the time interval during which the voltage of pulse 130 remains above the discriminator voltage.

The digital pulses produced by amplifier 132 are provided to a resistance capacitance network having a resistance R and a capacitor having a capacitance C. The capacitor is charged during each digital pulse, i.e. whenever the output of amplifier 132 is at the high level. The RC network generates an output V_{DT} which increases with the charge to the capacitor. Accordingly, voltage V_{DT} represents the total discriminator time for a given sampling interval. Concentration is calculated every 0.10 seconds.

The time constant for the RC circuit is preferably about equal to the signal sampling time, and considerably greater (by orders of magnitude) than the expected widths of the digital pulses.

There is a tendency of V_{DT} to underestimate the actual dead time, and the tendency becomes stronger as particle or droplet densities increase. In accordance with the present invention, system 16 is tested with challenges of known particle sizes and concentrations to determine the relationship between particle concentration and network output V_{DT} to determine a correction function or constant. The resulting constant corrects V_{DT} to particle or droplet concentrations, and is stored to microprocessor 38. Then, in conjunction with providing network output V_{DT} to the microprocessor, the stored function is applied to the voltage to determine particle concentrations. In general, the function is used to determine concentration based on a numerical particle count divided by a product of an adjusted sampling time and the flow rate, which is proportional to the concentration of non-volatile analyte exiting HPLC column 26. The adjusted sampling time is determined by subtracting the discriminator time from the actual sampling time. Thus, a correction factor is applied to the numerical count to yield a higher concentration than the count otherwise would indicate, taking into account the factors noted above.

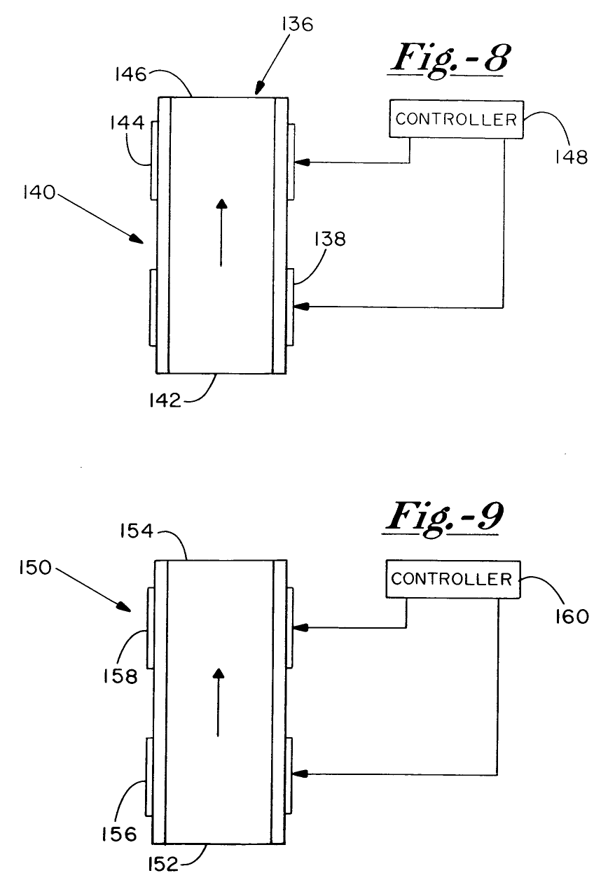

In one preferred version of the HPLC system, the condensation particle counter can be tuned to exhibit a desired threshold size for droplet growth and a desired droplet growth rate. FIG. 8 schematically shows a CPC 136 with a thermoelectric device 138 surrounding a droplet growth column 140 along a saturation region 142, and a heater 144 surrounding the growth column along a droplet growth region 146. A controller 148 is operable to individually set the temperatures of devices 138 and 144, thus to set the temperatures in the respective regions.

Controller 148 is used to adjust a saturation region temperature T_{S} and a growth region temperature T_{G} with respect to each other, as well as individually. An increase in the difference between temperatures T_{G} and T_{S} lowers the nucleation threshold, and thus increases the number of particles counted by the CPC for any given aerosol exhibiting a range of particle sizes. In addition, the rate of droplet growth can be increased by raising both temperatures T_{G} and T_{S} by a given amount, retaining the difference between these temperatures. This adjustment, likewise, tends to increase the particle count resulting from a given aerosol sample.

In accordance with another aspect of the invention, the HPLC system includes a condensation particle counter equipped to use a variety of different working or condensing liquids, for example both water and butyl alcohol. Effective use of both of these fluids requires a reversal in the saturation region temperature T_{S} and growth region temperature T_{G}.

To this end, FIG. 9 shows a CPC droplet growth column 150 including a saturation region 152 and a droplet growth or condensation region 154 downstream of the saturation region. An upstream thermoelectric device 156 surrounds the growth column along saturation region 152. A downstream thermoelectric device 158 surrounds the column along the condensation region. A controller 160 is operably coupled to the thermoelectric devices to determine temperatures T_{S} and T_{G} along the saturation and growth regions, respectively.

As noted above, the mass diffusivity of water exceeds the thermal diffusivity of air. As a result, particles traveling through droplet growth region 154 are being warmed, yet can serve as droplet growth sites because they remain sufficiently cool to condense the surrounding water vapor.

In contrast, the vapor of butyl alcohol has a mass diffusivity lower than the thermal diffusivity of air. In this case, the saturating temperature T_{S} is set higher than the droplet growth region temperature T_{G}. In this arrangement, although the tendency of the wick to generate vapor is reduced along the droplet growth region, this is overcome by the reduced temperature of the particles, which increases their capacity to serve as condensation sites.

According to several alternative liquid chromatography systems, the dried aerosol is selectively modified to remove smaller more volatile components. For example, FIG. 10 illustrates part of an HPLC system 160 in which a filter assembly 162 is positioned along the aerosol path between a nebulizer 164 and a condensation particle counter 166. The filter assembly incorporates a series of diffusion screens 168 designed to entrap particles with high diffusion coefficients, i.e. particles sufficiently small to be driven in irregular paths due to random collisions with gas molecules. While larger particles tend to travel linearly through the diffusion screens, smaller particles tend to collide with the screen wires and are retained by surface-attractive forces.

The number of diffusion screens 168 can be changed to selectively alter the size distribution of the aerosol particles leaving filter assembly 162. In particular, increasing the number of screens captures and removes a larger proportion of the aerosol particles from the aerosol stream. As a result of this selective filtration, CPC 166 produces an increased signal response for volatile components.

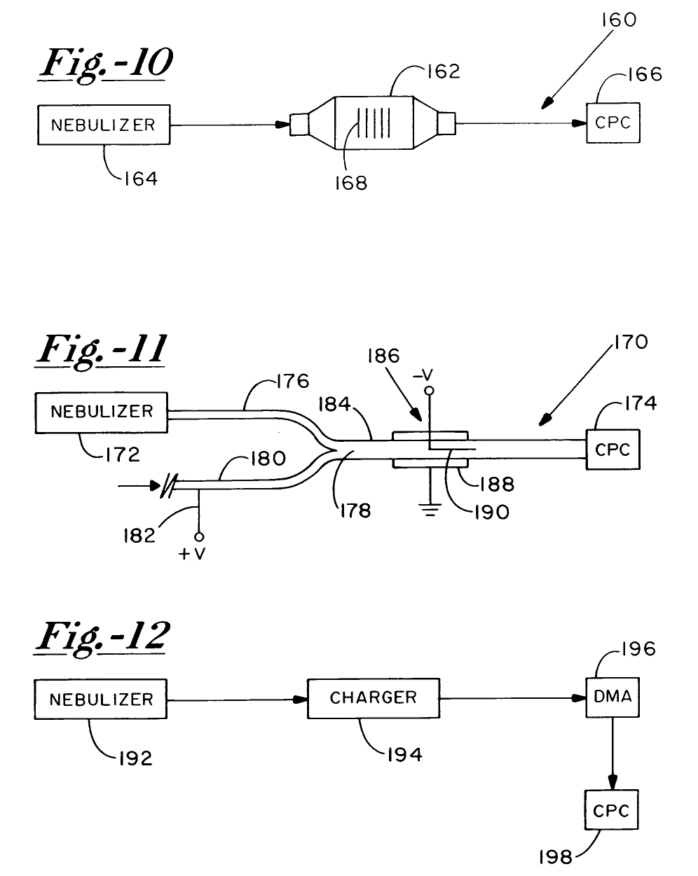

FIG. 11 schematically illustrates part of another alternative HPLC system 170 configured to electrostatically remove smaller particles from the aerosol stream between a nebulizer 172 and condensation particle counter 174. In this system, a conduit 176 conveys the dried aerosol away from the nebulizer towards a merger zone 178 which also receives a carrier gas conveyed by a conduit 180. A corona discharge needle 182, biased to a voltage +V, applies a unipolar charge to the carrier gas, in this case creating positive ions. At merger zone 178, the aerosol and the ionized gas combine to form positively charged reside particles and positive ions that travel downstream along a conduit 184.

An ion trap 186, disposed along conduit 184, includes an electrically grounded conductive cylindrical wall 188 and a conductive rod 190 electrically isolated from the wall. Rod 190 is negatively biased to a voltage −V to create an electrical field between the rod and the surrounding wall.

As the aerosol passes through ion trap 186, the electrical field causes the ions and the smaller particles, i.e. the higher electrical mobility components, to precipitate onto wall 188. The larger particles tend to continue flowing downstream toward CPC 174.

The ion trap voltage −V can be adjusted to selectively increase or decrease the maximum diameter of particles removed from the aerosol by the ion trap. Also, it is to be understood that various modifications can be employed to yield the same result e.g. reversing the polarities of rod 190 and corona discharge needle 182, biasing wall 188 in addition to or in lieu of rod 190, etc.

FIG. 12 illustrates another alternative approach for electrostatically removing selected particles from the dried aerosol stream before growing droplets, in particular a liquid chromatography system in which a dried aerosol stream emerging from a nebulizer 192 is conveyed through a charging device 194, then through a differential mobility analyzer (DMA) 196 before reaching a condensation particle counter 198.

Charging device 194 may employ a radioactive charger, or oppositely charged unipolar elements such as corona discharge needles. In either event, aerosol entering DMA 196 has a uniform charge distribution. In a further alternative approach, a unipolar charger is used in lieu of device 194.

The DMA guides the aerosol along a path between a cylindrical outer wall and an electrically charged rod centered and coaxial with the wall. Ions and charged particles with polarities opposite to that of the rod are attracted toward to rod. Higher mobility components precipitate along an upstream region of the rod. Particles with low electrical mobilities precipitate along a downstream region of the rod. Components having electrical mobilities within a selected range between “high” and “low” travel through a slot in the rod between the upstream and downstream regions. The portion of the aerosol containing these midrange components is provided to CPC 198. Thus, in addition to removing small particles, this approach entails removing larger particles as well, to confine the analysis to a particular desired range of particle sizes.

FIG. 13 illustrates part of a further alternative system directed to reducing the length of the aerosol flow path between a nebulizer 200 and a condensation particle counter 202. Nebulizer 200 is similar to the previously discussed nebulizers in that a sample liquid and a pressurized gas are provided through respective entrance conduits 204 and 206 to a merger zone 208, from which the resulting aerosol is conducted downstream through a conduit 210.

In a departure from the previous nebulizers, conduit 210 is formed by a cylindrical wall 212 that is permeable to the test liquid and adapted to transfer the test liquid vapor to the ambient environment surrounding nebulizer 200 by a process known as perevaporation. To enhance the process, it is desirable to maintain a low relative humidity environment about the nebulizer, although transfer of the sample liquid vapor continues so long as the environment is less humid than the aerosol inside conduit 210.

While not illustrated in FIG. 13, a heating element can be disposed along conduit 210 to promote evaporation as in previous embodiments. In either event, evaporation of the sample liquid proceeds at a more rapid rate due to the transfer of the vapor to the outside environment. A satisfactory material for wall 212 is sold by E. I. duPont de Nemours and Company of Wilmington, Del. under the brand name “Nafion”. While removing water vapor in this fashion, conduit 210 is similarly adapted for rapid removal of other liquids such as alcohols, amines, and ammonia. Due to the more rapid removal of these liquids, conduit 210 can provide a considerably shorter aerosol path from the nebulizer to the CPC, and yet provide substantially dry residue particles to the CPC for droplet growth. Conduit 210 can be built into the nebulizer as illustrated, or alternatively can be provided as a separate component along the aerosol path from a nebulizer to a condensation particle counter.

By allowing the test liquid paper to permeate through wall 212 to the ambient environment, conduit 210 tends to lower the dew point of the aerosol. This promotes evaporation without the need to raise the aerosol temperature. The ability to dry the aerosol without heating it considerably enhances the capacity of the system to measure more volatile analytes.

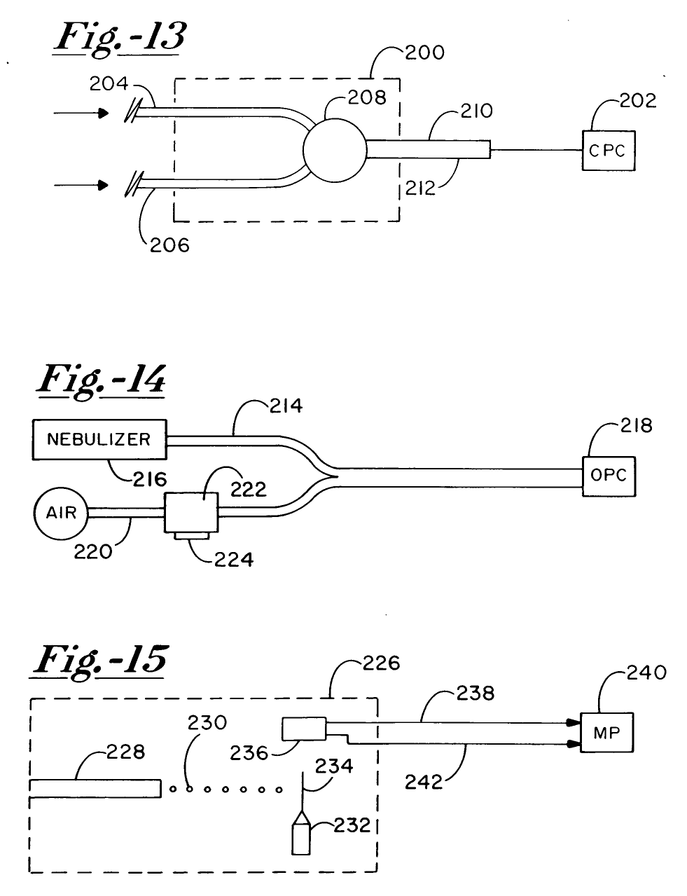

FIG. 14 illustrates part of an alternative HPLC system in which a conduit 214 conveys a substantially dried aerosol from a nebulizer 216 to an optical particle counter 218. A conduit 220 conveys pressurized air or another pressurized gas to the optical particle counter. A saturator 222, disposed along conduit 220, contains water, butyl alcohol or another working medium in liquid form. A heater 224 along the saturator raises the temperature of the gas, and at the same time promotes evaporation of the working medium to substantially saturate the gas.

Upstream of optical particle counter 218 is a merger region fluid coupled to conduits 214 and 220 for combing the aerosol and the saturated gas. Due to its lower temperature as compared to the saturated gas, the aerosol upon merger tends to cool the gas, leading to supersaturation and condensation of the working medium onto the aerosol particles. This leads to the growth of droplets, which are optically sensed as before.

FIG. 15 illustrates a feature that can be incorporated into any of the preceding condensation particle counters to enhance the dynamic range of the system involved. As represented schematically, a condensation particle counter 226 has a droplet growth column 228 disposed to receive dried particles of an aerosol and, through condensation of a working medium, provide as its output an aerosol including suspended droplets 230.

Downstream, a laser diode 232 generates a laser beam 234 that intersects the aerosol stream. Light scattered by droplets 230 is received by a photodetector 236 configured to sense droplets 230 individually, providing a signal via a line 238 to a processor 240 each time one of the droplets traverses a viewing volume determined by the intersection of laser beam 234 and the aerosol path. Photodetector 236 further is configured to sense multiple droplets simultaneously by generating an electrical signal having an amplitude proportional to the amplitude of light scattered in concert by multiple particles. This signal is provided to the processor via a line 242.

Photodetector 236 provides for high accuracy at low analyte concentrations, based on the droplet count over a given sampling time. When an analyte concentration becomes too high for individual counting, processor 240 is configured to use the active analyte concentration input from line 240, i.e. the photometric measurement.

Thus, in accordance with the present invention, a system for monitoring analyte concentrations in water and other liquids generates more reliable information virtually in real time, to facilitate more effective management of processes that depend on analyte identification and measurement. The system can be tuned to adjust nucleation thresholds and droplet growth rates, and accounts for coincidence episodes and thermal depletion to extend the useful range for generation of concentration data based on particle counts.

What is claimed is:

1. A system for measuring analyte concentrations in liquids, including:
an analyte separation stage adapted to separate different analytes in a liquid sample primarily into different regions within the liquid sample, thereby to produce a separation stage output in which a plurality of different analytes are so separated;
a nebulizing stage downstream of the analyte separation stage adapted to generate an aerosol stream composed of droplets of the separation stage output suspended in a carrier gas;
an evaporation stage downstream of the nebulizing stage adapted to substantially evaporate the liquid, whereby the aerosol leaving the evaporation stage is composed of residue particles of the different analytes suspended in the carrier gas;
a saturation stage disposed downstream of the evaporation stage, maintained substantially at a first temperature, and adapted to merge the aerosol with a working medium vapor having a mass diffusivity higher than a thermal diffusivity of the carrier gas, to substantially saturate the aerosol with the working medium vapor;
a condensation stage disposed downstream of the saturation stage, maintained at a second temperature above the first temperature, and adapted to merge further working medium vapor with the substantially saturated aerosol to supersaturate the aerosol and thereby cause droplet growth through condensation of the working medium onto the residue particles; and
a sensing stage downstream of the condensation stage adapted to optically sense the droplets and generate electrical signals useful in indicating analyte concentrations.

2. The system of claim 1 wherein:
the analyte separation stage comprises a liquid chromatography column adapted to cause different non-volatile analytes to travel through the chromatography column at respective different rates as the liquid sample progresses through the column, whereby the different regions exit the chromatography column at different times.

3. The system of claim 2 further including:
an information processing stage coupled to the sensing stage to receive the electrical signals and generate analyte concentration information based on the electrical signals.

4. The system of claim 3 wherein:
the aerosol stream includes temporally separated portions corresponding to the different regions exiting the chromatography column, whereby the corresponding electrical signals and analyte concentration information indicate different concentrations individually associated with different analytes.

5. The system of claim 1 wherein:
the evaporation stage comprises a heating element for heating the aerosol to facilitate evaporation of the liquid.

6. The system of claim 1 wherein:
the saturation stage and condensation stage comprise, respectively, a saturation region and a supersaturation region of a condensation particle counter.

7. The system of claim 6 further comprising:
a first temperature maintenance component adapted to maintain the first temperature along the saturation region, and a second temperature maintenance component adapted to maintain the second temperature along the supersaturation region.

8. The system of claim 7 wherein:
the first and second temperature maintenance components are adjustable to selectively vary the first temperature, the second temperature, and a difference between said temperatures.

9. The system of claim 6 further including:
a holding component disposed along the saturation region and the supersaturation region adapted to receive the working medium in liquid form and release the working medium in vapor form to the aerosol along the saturation and condensation stages.

10. The system of claim 1 wherein:
the sensing stage comprises a coherent energy beam intersecting the aerosol stream and a photodetector disposed proximate the aerosol stream to detect alterations or interruptions in transmission of the coherent energy as the droplets intersect the beam.

11. The system of claim 10 wherein:
the sensing stage further comprises a photometric detector for measuring an amplitude of the coherent energy scattered simultaneously by pluralities of the droplets.

12. The system of claim 1 further including:
a particle selection stage disposed between the evaporation stage and the saturation stage, adapted to selectively remove from the aerosol particles having sizes less than a predetermined threshold.

13. The system of claim 12 wherein:
the selection stage is adapted to electrostatically remove the particles.

14. The system of claim 1 further including:
means for moving the aerosol through the saturation stage and the condensation stage in a substantially laminar flow.

15. The system of claim 1 wherein:
the carrier gas consists essentially of air, and the working medium consists essentially of water.

16. The system of claim 1 further including:
means for introducing a dry gas along the evaporation stage for merger with the aerosol to sustain evaporation of the liquid.

17. A process for configuring the system of claim 3 to minimize erroneous counts due to increases in residue particle concentration, including:
while testing the system with different particle challenges of known particle sizes and concentrations, generating a plurality of voltages V_{DT} indicating discriminator time and individually associated with the different challenges;
using the information processing stage to store an operative linkage associating the discriminator time voltage levels V_{DT} and the corresponding particle concentrations; and
configuring the information processing stage to generate a corresponding output indicating a particle concentration responsive to receiving an electrical signal corresponding to a given discriminator time voltage level V_{DT}.

18. A system for analyzing liquids, including:
an analyte separator adapted to separate different analytes in a liquid sample primarily into different regions within the liquid sample, thereby to produce a separator output in which a plurality of different analytes are so separated;
a nebulizer fluid coupled to receive at least a portion of the separator output, and to generate an aerosol composed of droplets of the liquid suspended in a carrier gas;
a conduit structure for guiding travel of the aerosol in an aerosol stream away from a merger zone of the nebulizer, wherein at least a portion of the conduit structure is permeable to the liquid to promote an evaporation of the liquid and migration of the vapor through said portion of the conduit to an exterior thereof as the aerosol is conveyed along the conduit structure, whereby the aerosol leaving the conduit structure is composed of residue particles of the analytes suspended in the carrier gas; and
a concentration indicating component disposed to receive the aerosol leaving the conduit structure and adapted to indicate analyte concentration based on the residue particles received.

19. The system of claim 18 wherein:
the concentration indicating component comprises a droplet growth component disposed downstream of the conduit structure to receive the aerosol and merge the aerosol and a working medium vapor to supersaturate the aerosol and thereby cause droplet growth through condensation of the working medium onto the residue particles; and
a droplet sensing component downstream of the condensation component adapted to optically detect the droplets and generate electrical signals indicating analyte concentrations.

20. The system of claim 18 wherein:
the droplet growth component comprises a saturation stage adapted to merge the aerosol and the working medium vapor to substantially saturate the aerosol with the working medium vapor, and condensation stage downstream of the saturation stage and maintained at a condensation stage temperature different from the saturation stage temperature to merge further working medium vapor and the substantially saturated aerosol to supersaturate the aerosol and thereby cause growth of the droplets through condensation of the working medium onto the residue particles.

21. The system of claim 18 wherein:
the droplet growth component comprises a first conduit for conveying aerosol at a first temperature, a second conduit for conveying a gas saturated with a working medium vapor at a second temperature higher than the first temperature, and a droplet growth region fluid coupled to the first and second conduits to merge the aerosol and the saturated gas to achieve supersaturation and resulting droplet growth through condensation of the working medium onto the aerosol particles.

22. A system for analyzing liquid samples, including:
an analyte separator adapted to separate different analytes in a liquid sample primarily into different regions within the liquid sample, to produce a separator output in which a plurality of different analytes are so separated;
a nebulizer fluid coupled to receive at least a portion of the separator output in a merger zoned thereof and to generate an aerosol composed of droplets of the liquid suspended in a carrier gas;
an evaporation stage downstream of the nebulizer adapted to substantially evaporate the liquid whereby the aerosol leaving the evaporation stage is composed of residue particles of the different analytes suspended in the carrier gas;
an electrostatic selector disposed downstream of the evaporation stage and adapted to selectively remove, from the aerosol, residue particles having electrical mobilities above a predetermined threshold; and
a concentration indicating component downstream of the electrostatic selector, adapted to generate analyte concentration information based on the residue particles received from the selector.

23. The system of claim 22 wherein:
the concentration indicating component comprises a condensation particle counter, adapted to cause growth of droplets through condensation of a working medium onto the residue particles, then optically sense the resulting droplets to generate indications of analyte concentrations.

24. The system of claim 22 wherein:
the selector comprises an electrical charging device adapted to apply a unipolar charge to the residue particles, and an ion trap for removing particles having electrical mobilities above a predetermined threshold.

25. The system of claim 22 wherein:
the selector comprises a neutralizer adapted to apply a predetermined charge distribution to the residue particles, and a differential mobility analyzer disposed downstream of the neutralizer to receive the charged particles.

26. A device for generating an aerosol composed of multiple droplets of a liquid, including:
a housing forming a mixing chamber having (i) a liquid entrance for receiving a sample liquid into the chamber, (ii) a primary orifice having a first diameter for receiving a pressurized gas into the chamber for merger with the sample liquid to generate an aerosol composed of multiple droplets of the sample liquid suspended in the gas, and (iii) a secondary orifice having a second diameter for conducting the aerosol out of the chamber;
wherein the second diameter is less than a major dimension of the mixing chamber taken in a direction substantially perpendicular to an axis of the secondary orifice so as to restrict flow out of the mixing chamber to generate a back pressure in opposition to entry of the sample liquid and the pressurized gas into the chamber.

27. The device of claim 26 wherein:
the second diameter is less than one half of the major dimension of chamber.

28. The device of claim 26 wherein:
the second diameter is larger than the first diameter.

29. The device of claim 26 wherein:
the mixing chamber is cylindrical and coaxial with the secondary orifice.

30. The device of claim 29 wherein:
the primary orifice is coaxial with the secondary orifice and the chamber.

31. The device of claim 29 wherein:
the chamber has an axial length less than a diameter of the chamber and greater than the second diameter.

32. The device of claim 26 further including:
an impactor coaxial with the mixing chamber and spaced apart axially from the secondary orifice downstream of the chamber, said impactor having a convex upstream surface cooperating with a concave surface of the housing to form a generally hemispherical path for conveying the aerosol away from the chamber.

33. The device of claim 32 wherein:
the impactor is movable axially with respect to the housing to selectively adjust the axial spacing between the impactor and the secondary orifice.

34. A device for optically detecting fine particles in an aerosol, including:
a housing having an inlet for receiving an aerosol consisting essentially of substantially dry submicrometer residue particles suspended in a carrier gas, and a passage for conveying the aerosol in a steady stream through the housing along a saturation region and along a supersaturation region downstream of the saturation region;
a holding component disposed along the passage, adapted to contain a condensing medium in liquid form and to release the condensing medium in vapor form as the aerosol is conveyed along the passage;
a first temperature maintenance device disposed proximate the passage along the saturation region adapted to maintain the saturation region substantially at a first temperature;
a second temperature maintenance device disposed proximate the passage along the supersaturation region adapted to maintain the supersaturation region substantially at a second temperature different from the first temperature;
a controller operably associated with the temperature maintenance devices for selectively setting the first temperature, the second temperature, and a difference between the first and second temperatures, to selectively vary a nucleation threshold at which the particles are capable of serving as nuclei for condensation of the working medium to grow droplets; and
a droplet detector disposed at a sensing location downstream of the passage and adapted to sense the droplets resulting from said condensation as they pass the sensing location.

35. The device of claim 34 wherein:
the temperature maintenance devices and the controller are configured to maintain the first temperature within a first temperature range, and to maintain the second temperature within a second temperature range that is higher than the first temperature range.

36. The device of claim 34 wherein:
the temperature maintenance devices and the controller are configured to maintain the first temperature within a first temperature range, and to maintain the second temperature within a second temperature range that is lower that the first temperature range.

37. The device of claim 34 wherein:
the temperature maintenance devices and controller are configured to maintain the first temperature and the second temperature within respective first and second substantially overlapping temperature ranges, whereby the controller is operable alternatively to provide a first temperature higher than the second temperature and a first temperature lower than the second temperature.

38. The device of claim 34 further including:
a working medium holding component disposed along the passage, adapted to receive and contain a working medium in liquid form and release the working medium in vapor form as the aerosol is conveyed along the passage.

39. The device of claim 34 wherein:
said passage is cylindrical, and the holding component comprises an annular porous liner contiguous with and surrounded by a portion of the housing that defines the passage.
